(19) United States
(12) Patent Application Publication
(10) Pub. No.: US 2011/0238670 A1
(43) Pub. Date: Sep. 29, 2011

(54) CROWD-SOURCING AND CONTEXTUAL RECLASSIFICATION OF RATED CONTENT

(75) Inventor: Marc E. Mercuri, Bothell, WA (US)

(73) Assignee: MICROSOFT CORPORATION, Redmond, WA (US)

(21) Appl. No.: 12/729,243

(22) Filed: Mar. 23, 2010

(51) Int. Cl. G06F 17/30

(52) U.S. Cl. 707/748; 707/E17.044; 707/E17.005

(57) ABSTRACT

A content evaluation system is described herein that empowers end users and organizations to share their interpretation of an automatically generated sentiment score. The system provides a control that a user can move to indicate agreement or disagreement with an automatic score. The system adds metadata to a revised score based on the user's feedback that tracks information about the user to consider different demographic contexts. The system performs rescoring with the user-provided scores with contextual consideration, and then exposes the rescored values on context specific endpoints. The system provides a crowd-sourcing approach that scales extremely well, adds more accuracy because individuals within known demographic categories/contexts do the scoring, and generates value-added data products that can be sold/re-sold.

### BACKGROUND

The Internet is filled with many different types of content, such as text, video, audio, and so forth. Many sources produce content, such as traditional media outlets (e.g., news sites), individual bloggers, retail stores, manufacturers of products, and so forth. Some web sites aggregate information from other sites. For example, using a Really Simple Syndication (RSS) feed, a web site author can make content available for other sites or users to consume, and an aggregating site can consume various RSS feeds to provide aggregated content.

Content publishers often provide a facility for rating content or receiving a sentiment about the content from a user (e.g., positive, negative, or some scale in between). For example, a video may include a display of five stars that a user can click on to rate the video from one to five stars. Publishers may also display a rating based on input from multiple users and use ratings in searches (e.g., to return the highest rated content or sort content by rating) or other workflows. Organizations may internally or externally rate content, such as determining which advertising campaign among several choices will be most effective for a target demographic. In the world of the real-time web, it is useful for organizations to receive contextually relevant evaluation of content.

One area where content sentiment may be determined is in protecting an organization's reputation. An organization's reputation may be one of the most important assets that the organization possesses. For example, a company's sales may be determined, in part, by how well customers trust the company to deliver products of a high quality and on time to the customer. Many customers determine whether they will deal with a particular business by how a customer service department of the business will handle things that go wrong (e.g., a missing shipment, damaged goods, and so on). Many organizations have built substantial reputations around the quality of their customer service and others have suffered due to negative impressions of their customer service. Customers may upload content to various sources that affect an organization's reputation.

Given the volume of data, most content can be evaluated by an automated algorithm to provide mixed success. Algorithms are typically trained on a generic result set, and therefore the interpretation of accuracy can vary widely when viewed in various contexts such as generational perception, geographic specific slang, geographic specific cultural beliefs, business verticals, and so forth. An organization may initially rate content automatically and then follow up with a manual process to tune the ratings or interpret what the ratings mean.

Unfortunately, sentiment differs for different people. Just because millions of teenagers like a particular content item is no guarantee that senior citizens will like the content item. Likewise, content that is humorous in one country or language may fall flat or even worse, be offensive, in other locales or languages. In the world of the real-time web, organizations need to be able to readily identify content sentiment for a variety of different groups and for a variety of different purposes. In addition, organizations need to be able to verify automatic sentiment algorithms and tune those algorithms based on experience.

### SUMMARY

A content evaluation system is described herein that empowers end users and organizations to share their interpretation of an automatically generated sentiment score. The system may provide a simple visual mechanism, such as a slider bar, that a user can move to indicate agreement or disagreement with an automatic score. The system adds metadata to a revised score based on the user's feedback that tracks information about the user to consider different demographic contexts. The system performs rescoring with the user-provided scores with contextual consideration, and then exposes the rescored values on context specific endpoints. The content evaluation system provides a crowd-sourcing approach that scales extremely well, adds more accuracy because individuals within known demographic categories/contexts do the scoring, and generates value-added data products that can be sold/re-sold. In addition, the resulting data set can be used to improve automated content evaluation algorithms, thereby increasing the algorithms' accuracy and providing context-specific variants. Thus, the content evaluation system provides a mechanism for individuals and organizations to override values assigned by an automated content evaluation process, while providing context about the individual/organization providing the override of the algorithm score.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the content evaluation system, in one embodiment.

FIG. 2 is a flow diagram that illustrates processing of the content evaluation system to rate content, in one embodiment.

FIG. 3 is a flow diagram that illustrates processing of the system to receive a sentiment rating override from a user for a content item, in one embodiment.

FIG. 4 is a flow diagram that illustrates processing of the system to reevaluate aggregate scoring, in one embodiment.

FIG. 5 is a block diagram that illustrates an operating environment of the content evaluation system, in one embodiment.

### DETAILED DESCRIPTION

A content evaluation system is described herein that empowers end users and organizations to share their interpretation of an automatically generated sentiment score. The system may provide a simple visual mechanism, such as a slider bar, that a user can move to indicate agreement or disagreement with an automatic score. The system adds metadata to a revised score based on the user's feedback that tracks information about the user to consider different demographic contexts. For example, the system allows an administrator to later determine content impressions among users of a particular age range, gender, social status, and so forth. The system performs rescoring with the user-provided scores with contextual consideration, and then exposes the rescored values on context specific endpoints. The content evaluation system provides a crowd-sourcing approach that scales extremely well, adds more accuracy because individuals within known demographic categories/contexts do the scoring, and generates value-added data products that can be sold/re-sold. In addition, the resulting data set can be used to improve automated content evaluation algorithms, thereby increasing the algorithms' accuracy and providing context-specific variants. Thus, the content evaluation system provides a mechanism for individuals and organizations to override values assigned by an automated content evaluation process, while providing context about the individual/organization providing the override of the algorithm score. This revised score has context-specific meta-tags associated with it, and is reviewed in volume with the revised scores of other individuals. The system then recalculates context-specific scoring and exposes it via a web service for consumption in web sites, web services, and applications.

In some embodiments, the content evaluation system provides a mechanism for involving people and demographic context for the contextual re-scoring of information. As described herein, the system may present a user with an automated score that reflects a positive or negative impression of a content item, and allow the user to indicate agreement or disagreement with the automated score. The user(s) have an associated user profile previously created and stored by the system that captures demographic information about the user, so that when the user overrides content storing the system can store both the modified score and demographic characteristics associated with the user that modified the score. After many such users perform similar actions, the system can roll up statistics describing modifications by users having similar demographics characteristics to identify trends in content evaluation among particular demographic categories.

In some embodiments, the content evaluation system collects and aggregates user score modifications from many different users to identify trends. For example, the system may provide a website where users can view and evaluate content. The website may provide an indication of an automated score for the content or a score that reflects historical user feedback received about a content item over time. The system stores data points according to demographic tags, so that an administrator can later generate statistical analyses of the scoring data that is sliced according to a variety of demographic combinations. For example, an administrator may wish to know impression of a particular content item among females age 15-25, then later among females of all ages living on the west coast. By storing impression information associated with known demographic traits at the time of receiving individual impressions, the system facilitates later analysis according to a variety of different criteria.

In some embodiments, the content evaluation system exposes an application-programming interface (API) for users, services, and applications to access content evaluation information compiled by the system based on user impressions and to generate reports and statistical analysis based on collected data. The system may provide a website, web service, or other interface to provide widespread access to data collected by the system, and so that other applications and systems can identify and use data variants identified by the system to drive larger solutions and workflows.

In some embodiments, the content evaluation system embeds a mechanism for sentiment override in an application or website (e.g. a slider control). Upon receiving a sentiment override, the website calls a web service and provides a content identifier, a revised score, and demographic information for the individual/organization providing the revised score (e.g., age, geography, business vertical, and so forth). The web service stores the revised score in a hosted data store (e.g., an online database or cloud-based storage service). The service evaluates the demographics of the individual/organization providing the revised score (e.g., age, geography, sentiment, business vertical, and so on), assigns appropriate metadata tags to the content to keep track of the demographics, and creates records for the revision in the database. Software periodically evaluates crowd-sourced scores with the context of meta-data tags, and re-scores content along multiple dimensions for the different contexts (e.g., age, geography, business verticals, and so on). Revised scores are then stored in a hosted database. A web service exposes updated, context-specific scores for content, which are then consumed by websites, services, and applications that access the content evaluation system.

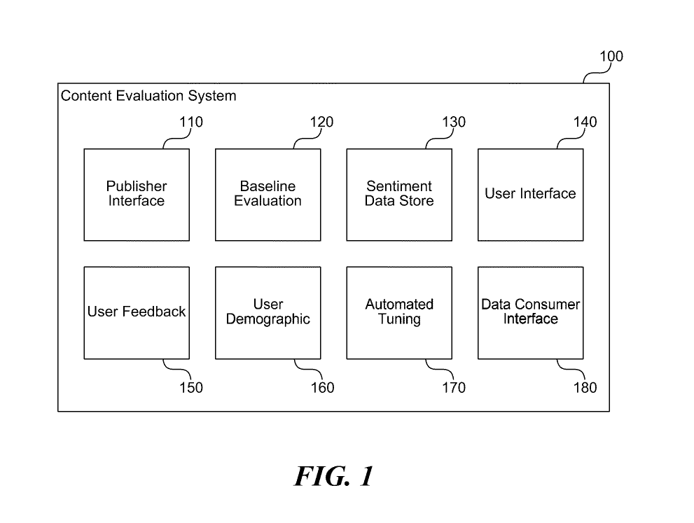

FIG. 1 is a block diagram that illustrates components of the content evaluation system, in one embodiment. The system 100 includes a publisher interface component 110, a baseline evaluation component 120, a sentiment data store 130, a user interface component 140, a user feedback component 150, a user demographic component 160, an automated tuning component 170, and a data consumer interface component. Each of these components is described in further detail herein.

The publisher interface component 110 provides an interface through which publishers can add content to the system to be automatically and manually rated. For example, a publisher may post a new video to a website using the publisher interface. The publisher interface component 110 also provides a way for the publisher to view the current rating status of one or more content items and to obtain reports related to various demographic profiles.

The baseline evaluation component 120 automatically determines a rating sentiment for a content item. The component 120 may use a variety of different automatic rating algorithms to develop a baseline rating for a content item. Users of the system 100 will tune the baseline rating by providing feedback about the accuracy of the automatic rating in the user's opinion. The baseline evaluation component 120 may employ multiple automatic methods of rating content, and may combine the scores of multiple methods (e.g., averaging). In addition, the baseline evaluation component 120 receives tuning information based on received user ratings over time that the component 120 can use to improve the quality and accuracy of baseline automatic sentiment ratings.

The sentiment data store 130 stores rating information for one or more content items. The data store may include a disk drive, file system, database, storage area network (SAN), cloud-based storage server, or other facility for persisting data. For example, the system 100 may use a database that includes a table with rows that each stores a particular user rating and demographic metadata that identifies demographic traits of each user that provides a sentiment rating. Other components can query the sentiment data store 130 in various ways to extract information relevant to a particular report or other goal. For example, a component can query for ratings from users of a particular age range or geographic region of residence.

The user interface component 140 provides a user interface through which users of the system 100 can provide manual sentiment ratings through a user interface control. For example, the user interface may display content items to the user and provide a slider control next to each content item through which the user can specify his opinion of the content item (e.g., liked it, did not like it) on a scale. The user interface component 140 may also provide other controls, pages, or interfaces to the user for searching for content items, specifying profile/demographic information, receiving credit for rating content items, and so forth.

The user feedback component 150 receives user feedback from the user interface and stores the user feedback in the sentiment data store 130. For example, if a user slides a slider control all the way to a negative value, the component 150 may record a data row indicating that the user did not like the content item. The row may include a content identifier, the user's specific sentiment rating for the item, and demographic characteristics associated with the user.

The user demographic component 160 tracks user demographic information to be used when users rate content items and when data consumers receive reports about user sentiment ratings. The user demographic component 160 may maintain a stored profile for each user that includes information about the user (e.g., age, residence location, gender, affiliations, and so forth). Alternatively or additionally, the component 160 may obtain similar information from the user at the time of receiving a rating indication. For example, users may anonymously access the system 100 but the system may ask users to give their age or other demographic information before providing content items for the users to rate.

The automated tuning component 170 creates a feedback loop between automated evaluation and actual rating values received from users. Automated evaluation attempts to determine a baseline level of quality of content items, but may fail to accurately predict what users will like. If the user ratings indicate strong disagreement or countertrends to the automated evaluation results, then the component 170 may incorporate user feedback to tune the automated algorithm to produce better results. For example, the tuning may relax an assumption of the automated algorithm (e.g., that longer content will not be rated as highly) or tune parameters of the automated algorithm (e.g., by adjusting a threshold level of volume before a content item is determined to be annoying, either universally or in specific contexts). Over time, user ratings directed back to the automated evaluation by the automated tuning component 170 improves the accuracy of automated evaluation to provide better initial baseline results (which can then be further tuned by user input).

The data consumer interface component 180 provides aggregate data about content item sentiment to one or more data consumers. For example, the component 180 may provide an API (e.g., a web service API or other protocol) through which data consumers can submit data queries and receive matching results. For example, a data consumer may request user sentiment towards a particular content item for users of a specific demographic or from users of all groups. The system 100 may automatically identify trends and create data groups that data consumers can enumerate and about which data consumers can query additional information. For example, the system 100 may determine that sentiment among a particular age group for a particular content item (or type of content item) is much more positive than for other age groups. If the content item is an advertisement, then this information can be used by the data consumer to better target the advertisement at the age group that will respond most positively.

The computing device on which the content evaluation system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

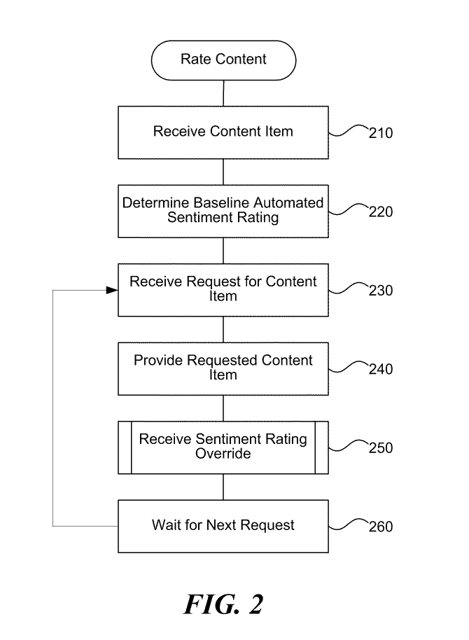

FIG. 2 is a flow diagram that illustrates processing of the content evaluation system to rate content, in one embodiment. The system performs the following steps after the system receives a new content item for which a publisher or other party wants to determine and track a sentiment rating that indicates the appeal of the content item to an audience of users. Beginning in block 210, the system receives a content item for which a publisher wants to determine and track a sentiment rating. For example, a publisher may upload a content item to a web service through a publisher interface, and the web service may implement the system described herein and provide ratings for content items through automated and crowd-sourced facilities.

Continuing in block 220, the system determines a baseline automated sentiment rating for the received content item. The system may use one or more well known automated content rating algorithms to determine a baseline rating or may set an initial default rating (e.g., 50%, three stars, or similar neutral value). The system may also incorporate tuning feedback from previous iterations of receiving user feedback that overrides baseline ratings to improve the baseline rating. Continuing in block 230, the system receives a request to access the received content item. For example, a content distributor may place the content item on a web site or other distribution source so that users can access the content item. The content item may include any type of content, such as text, image, video, audio, movies, presentation data, and so forth. The system may receive a content access request from a client web browser in response to a user directing the browser to access a web site.

Continuing in block 240, the system provides the requested content item for display to a user along with a control for receiving a user rating of the content item. For example, the system may provide an embeddable web control, MICROSOFT™ SILVERLIGHT™ application, or other embeddable object that displays the requested content and a slider or other control that the user can manipulate to score the user's sentiment towards the content item. For example, the user may slide the slider left if the user does not like the content item or right if the user likes the content item.

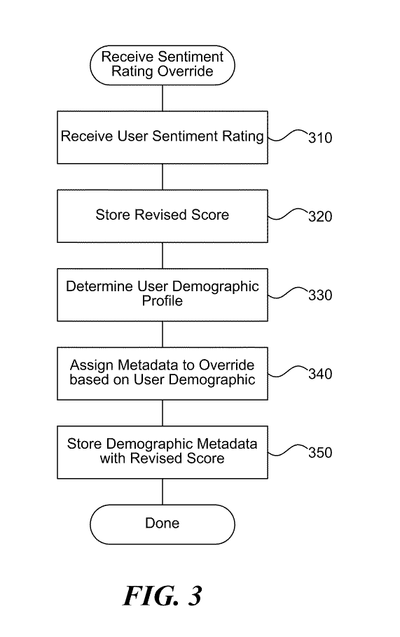

Continuing in block 250, the system receives a sentiment rating override from the user, as described further with reference to FIG. 3. Continuing the previous example, the user's manipulation of the slider control may cause the system to receive an HTTP POST or other data upload that specifies an identification of the content item, an identification of the user or of traits of the user, and the user's score for the content item. Continuing in block 260, the system waits for the next request to access the content item, then loops to block 230 to receive the request. The system may make content items available for rating indefinitely or for as long as a publisher requests that the content item be available. After block 250, these steps conclude.

FIG. 3 is a flow diagram that illustrates processing of the system to receive a sentiment rating override from a user for a content item, in one embodiment. Beginning in block 310, the system receives a rating of a content item from a user. For example, as described with reference to FIG. 2, the user may view a web page or other site that contains the content item, and upon viewing the item may provide a rating score for the content item that specifies the user's opinion of the content item. Continuing in block 320, the system stores the revised score in a data store for subsequent analysis and reporting. For example, the system may store the score in a database that includes individual and/or aggregate scoring information for one or more content items provided by publishers. The score may include a numeric value, enumeration value, Boolean indication of whether the user liked the content or not, or any other scoring paradigm for content (e.g., x out of 5 stores, and so forth).

Continuing in block 330, the system determines a demographic profile of the user that provided the received rating of the content item. For example, the system may determine the user's age, geographic location (e.g., based on coordinate information from a GPS module, software provided geolocation APIs or an IP address of the user's client machine), business vertical, or other trait related to the user. The system tracks demographics specified by a publisher or determined by the system to potentially distinguish user opinions of one group from another. Continuing in block 340, the system assigns metadata tags to a record associated with the user's revised score for the content item based on the determined demographic profile of the user. The system may store the user's raw demographic information (e.g., age) or may associate tags that specify particular relevant demographic brackets (e.g., an age 25 to 35 category). The record may contain multiple categories that apply to the user, such as age, location, gender, and so forth.

Continuing in block 350, the system stores the assigned metadata tags in association with the user's revised score so that subsequent reporting and analysis can process revised content item ratings based on demographic profiles. For example, a particular publisher may want to know what men age 30 to 40 thought about a particular content item, and can access the system and retrieve rating data for this and other demographics. After block 350, these steps conclude.

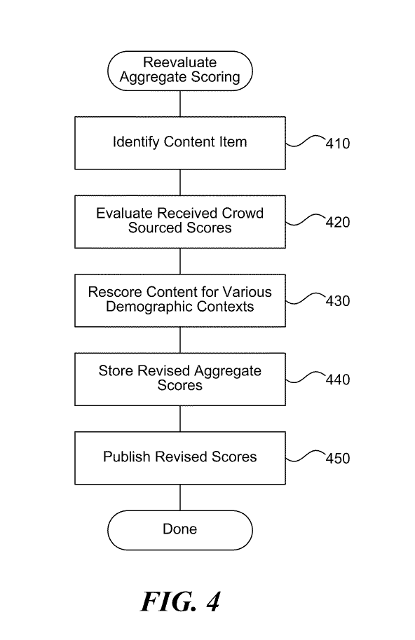

FIG. 4 is a flow diagram that illustrates processing of the system to reevaluate aggregate scoring, in one embodiment. The following steps occur periodically after a sufficient number of override ratings have been received for the system to update aggregated data for particular demographics. The system may track aggregated data for specified demographics or based on dynamically determined demographics. Beginning in block 410, the system identifies a content item for which the system is tracking sentiment rating information. For example, the system may include a database of multiple items for which the system is tracking rating information, and system may iterate through each content item periodically to update aggregate statistical information.

Continuing in block 420, the system evaluates received crowd sourced ratings of the identified content item based on metadata tags that identify demographic profiles of users that revised a rating of the content item. For example, the system may determine that there are updated scores available from users of a variety of genders and ages. Continuing in block 430, the system rescores the content item based on demographic contexts for which the system has received revised ratings. For example, if the system determined a baseline score or a score during a previous iteration for a content item for users that meet a demographic profile, then the system may rescore the content item based on overridden rating information received from users that meet that demographic profile. If the user ratings differ significantly from a result from an automatic scoring algorithm, then the system may store tuning parameters (not shown) to modify behavior of the automated algorithm to improve future results.

Continuing in block 440, the system stores in a data store revised aggregate scores for the content item according to one or more demographic contexts. For example, the system may update a score in a database of aggregated content rating information for one or more content items. Continuing in block 450, the system publishes the stored scores so that data consumers can determine user ratings of content items for one or more demographic profiles. For example, the system may provide a data consumer interface (e.g., a web service or other programmatic API or a user-accessible web page) through which data consumers can submit queries for identified content items and receive rating results based on the system's recorded data from users. After block 450, these steps conclude.

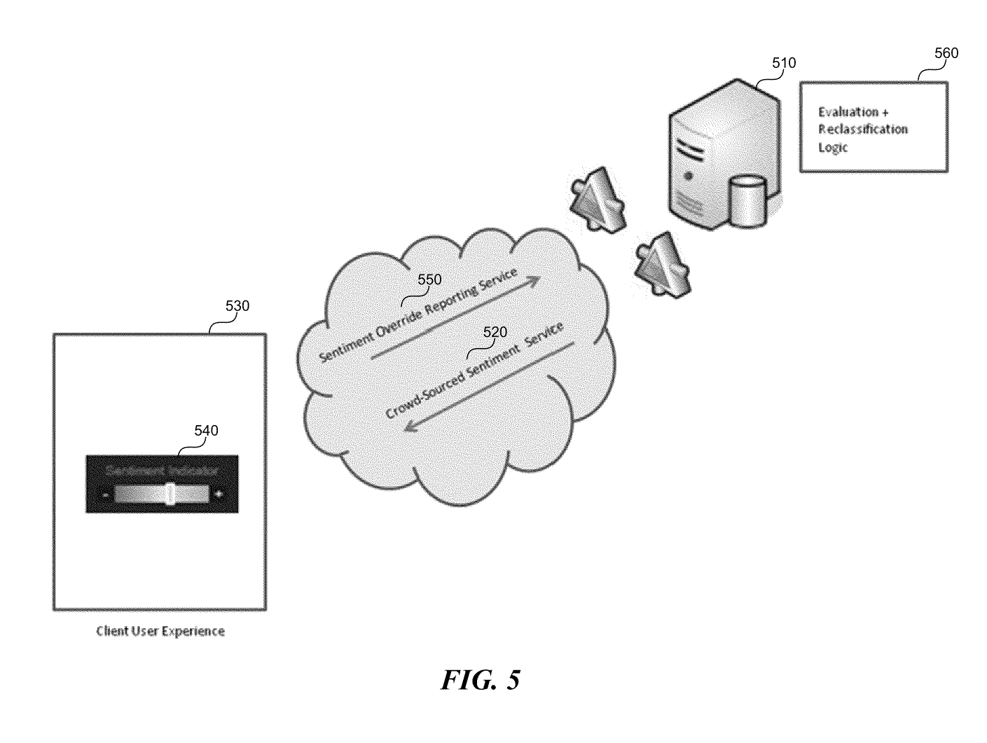

FIG. 5 is a block diagram that illustrates an operating environment of the content evaluation system, in one embodiment. A server computer 510 includes an implementation of the content evaluation system. The server computer 510 provides a crowd-sourced sentiment service 520 to one or more clients, such as client 530. The client provides a user experience that includes displaying a content item and a sentiment indicator 540 that a user can manipulate to indicate the user's opinion of the content item. For example, the user may slide the illustrated slider left to indicate sentiment that is more negative and right to indicate sentiment that is more positive. The client sends a sentiment override 550 to the server computer 510. The server computer system 510 provides the sentiment override to evaluation and reclassification logic 560 of the content evaluation system. The system incorporates the user evaluation of the content in an aggregated score (or scores) for the content that includes demographic information about users that have rated the content item, as described further herein.

In some embodiments, the content evaluation system allows site publishers to resell data. For example, a website such as the HuffingtonPost.com may resell data about user opinions of content on the site back to the content creator so that the content creator can improve the appeal of future content. A content creator that is an advertiser may determine that users of a certain demographic liked a Sci-Fi video but not a baby video, and thus the advertiser may make more Sci-Fi videos or allocate advertising dollars to advertise in and around Sci-Fi videos. This may allow the site publisher to make advertisements that are more appealing and that drive brand value and increase its customer base. Any site where content is displayed can become a platform for generating approval data for the content creator, regardless of who owns a site on which the content is published. The system can then aggregate approval data across all content providers to get a picture of what is happening universally.

In some embodiments, an operator of the content evaluation system gives data back to content sites to encourage adoption of the system. For example, in return for providing the system with rating information about content items, the system may reward a content site by providing a report to the content site that indicates which content user's like most. The system may break out statistical information about the users based on demographic profiles so that the content site operator can improve the content of the site for target demographic groups.

From the foregoing, it will be appreciated that specific embodiments of the content evaluation system have been described herein for purposes of illustration, but that various modifications may be made without deviating from the spirit and scope of the invention. Accordingly, the invention is not limited except as by the appended claims.

I/We claim:

1. A computer-implemented method for crowd-sourced rating of online content, the method comprising:
receiving an identification of a content item for which a publisher wants to determine and track a sentiment rating;
determining a baseline automated sentiment rating for the identified content item;
receiving a request to access the received content item based on a user request;
providing the requested content item for display to a user along with a control for receiving a user rating of the content item;
receiving a revised rating of the content item from the provided control;
determining a demographic profile of the user that provided the received rating of the content item;
assigning at least one metadata tag to a record associated with the user's revised score for the content item based on the determined demographic profile of the user; and
storing the assigned metadata tag in association with the received revised rating so that subsequent reporting and analysis can process revised content item ratings based on demographic profiles,
wherein the preceding steps are performed by at least one processor.

2. The method of claim 1 wherein receiving the identification of the content item comprises receiving a content item identifier from the publisher that distinguishes the content item from other content items.

3. The method of claim 1 wherein determining the baseline automated sentiment rating comprises incorporating tuning feedback from previous iterations of receiving user feedback that overrides baseline ratings to improve the baseline rating.

4. The method of claim 1 wherein receiving the request to access the content item comprises receiving a content access request from a client web browser in response to a user directing the browser to access a web site.

5. The method of claim 1 wherein providing the requested content item comprises providing an embeddable object that displays the requested content and a control that the user can manipulate to score the user's sentiment towards the content item.

6. The method of claim 1 wherein receiving the user rating of the content item comprises receiving an indication that the user manipulated the control to override an original sentiment indication provided by the control.

7. The method of claim 1 wherein determining the demographic profile of the user comprises receiving profile information from the user that describes one or more groups of which the user is a member.

8. The method of claim 1 wherein assigning metadata tags comprises assigning multiple demographic tags that correspond to groups to which the user belongs.

9. The method of claim 1 wherein storing the assigned metadata tag and revised rating comprises updating a database of content ratings to track impressions of users belonging to the user's demographic profile.

10. A computer system for crowd-sourced rating and reporting of online content, the system comprising:
a processor and memory configured to execute software instructions;
a publisher interface component configured to provide an interface through which publishers can add content to the system to be automatically and manually rated;
a baseline evaluation component configured to automatically determine a rating sentiment for a content item;
a sentiment data store configured to store rating information for one or more content items;
a user interface component configured to provide a user interface through which users of the system can provide manual sentiment ratings through a user interface control;
a user feedback component configured to receive user feedback from the user interface and stores the user feedback in the sentiment data store;
a user demographic component configured to track user demographic information as users rate content items and provide the demographic information to data consumers that receive reports from the system describing user sentiment ratings; and
a data consumer interface component configured to provide aggregate data about content item sentiment to one or more data consumers.

11. The system of claim 10 wherein the publisher interface component is further configured to provide a facility for the publisher to view the current rating status of one or more content items and to obtain reports related to demographic profiles of users that have rated the content items.

12. The system of claim 10 wherein the baseline evaluation component is further configured to receive tuning information based on received user ratings over time and applying the tuning information to improve quality and/or accuracy of baseline automatic sentiment ratings provided by the component.

13. The system of claim 10 wherein the sentiment data store is further configured to store data rows that each store a particular user rating and demographic metadata that identifies demographic traits of each user that provides a sentiment rating.

14. The system of claim 10 wherein the user interface component is further configured to display a content item to the user and provide a slider control next to the content item through which the user can specify his opinion of the content item.

15. The system of claim 10 wherein the user feedback component is further configured to store a content identifier of the content item, a received sentiment rating for the content item, and demographic characteristics associated with the user that provided the sentiment rating.

16. The system of claim 10 wherein the user demographic component is further configured to maintain a stored profile for each user that includes demographic information about the user.

17. The system of claim 10 wherein the user demographic component is further configured to receive user demographic information at the time of receiving a rating indication.

18. The system of claim 10 further comprising an automated tuning component configured to create a feedback loop between automated evaluation and actual rating values received from users by feeding tuning parameters to the baseline evaluation component based on received user modifications to automatically determined baseline ratings.

19. A computer-readable storage medium comprising instructions for controlling a computer system to reevaluate aggregate scoring of content items, wherein the instructions, when executed, cause a processor to perform actions comprising:
identifying a content item for which the system is tracking sentiment rating information;
evaluating received crowd sourced ratings of the identified content item based on metadata tags that identify demographic profiles of users that revised a rating of the content item;
rescoring the content item based on demographic contexts for which the system has received revised ratings;
storing in a data store revised aggregate scores for the content item according to one or more demographic contexts; and
publishing the stored scores so that data consumers can determine user ratings of content items for one or more demographic profiles.

20. The medium of claim 19 wherein rescoring the content item comprises rescoring the content item based on overridden rating information received from users that meet a specified demographic profile.
